(19) United States
(12) Patent Application Publication
(10) Pub. No.: US 2007/0290510 A1
(43) Pub. Date: Dec. 20, 2007

(54) Combustion Generator Enhancement Device

(76) Inventor: Robert ARATARI, Pompano Beach, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/763,704

(22) Filed: Jun. 15, 2007

Related U.S. Application Data
(60) Provisional application No. 60/814,336, filed on Jun. 16, 2006.

(51) Int. Cl. H02K 7/18

(52) U.S. Cl. 290/1 R

(57) ABSTRACT

The present invention provides a combustion generator device releasably engageable with a portable generator, including a housing defining an intake conduit, an interior chamber, and an outlet conduit having defining a fluid flow path. The intake conduit defines a first longitudinal axis, the interior chamber defines a second longitudinal axis, and the outlet conduit defines a third longitudinal axis, such that the first and second longitudinal axes are substantially perpendicular, the second and third longitudinal axes are substantially perpendicular, and an angle between the first longitudinal axis of the intake conduit and the third longitudinal axis of the outlet conduit is between approximately 110 and 120 degrees. A catalytic conversion assembly may be positioned within at least a portion of the interior chamber, and a muffler assembly may be positioned within at least a portion of the outlet conduit.

### CROSS-REFERENCE TO RELATED APPLICATION

This application is related to and claims priority to U.S. Provisional Patent Application Ser. No. 60/814,336, filed Jun. 16, 2006, entitled GENERATOR COMBUSTION ENHANCEMENT DEVICE, the entirety of which is incorporated herein by reference.

### STATEMENT REGARDING FEDERALLY SPONSORED RESEARCH OR DEVELOPMENT

n/a

### FIELD OF THE INVENTION

The present invention relates to a system for decreasing the toxic output of a combustion device, such as a gas-powered generator or the like.

### BACKGROUND OF THE INVENTION

In the aftermath of severe weather, such as hurricanes, blizzards, and the like, many people may find themselves without electricity for a prolonged duration of time. The duration of the outage typically depends on the severity of the storm. For example, recent hurricanes occurring along the southeastern coast of the United States have left millions of people without power for weeks at a time, if not longer. During this period of power outage, it is becoming more and more commonplace to employ the use of alternative sources to supply electricity in order to fulfill essential needs, such as refrigerating and preparing food, powering needed medical devices, etc. These alternative sources typically include gasoline-powered generators capable of providing the needed electrical power. Of course, like any other combustion-powered apparatus, these gas-powered generators create poisonous exhaust gases during operation, including carbon monoxide, nitric oxides and other dangerous hydrocarbons, which can easily asphyxiate a person should the fumes enter a house through an open window or door.

While the danger of such compounds may be alleviated by running a generator outdoors and away from enclosed areas to prevent a concentrated build-up of these substances, when used improperly, these fuel-burning appliances can quickly cause carbon monoxide poisoning, leading to serious injuries or even death. A typical 5.5-kilowatt home generator can produce the same amount of carbon monoxide as six idling cars, according to a study by the Centers for Disease Control and Prevention (CDC). As such, even in a garage with the door open or in a ventilated room in a house, carbon monoxide can accumulate rapidly and seep into the home, thereby overpowering sleeping occupants. Simply stated, carbon monoxide is an odorless, colorless poison gas that can cause a fatality in minutes.

Despite warnings to consumers that generators should be used outdoors only, far from doors, windows, and vents that could allow carbon monoxide to come indoors, there remains a misconception that it is somehow safe to run a generator in a garage as long as the garage door is open, or that it is safe to run a generator in a basement as long as a window is open. To the contrary, both scenarios have caused numerous deaths. For example, deaths associated with carbon monoxide from portable generators have risen drastically in recent years. In 1999, generators were involved with 6% of the total yearly estimated carbon monoxide poisoning deaths associated with all consumer products compared to 24% in 2002. In addition, after the 2004 hurricane season, the CDC and the Florida Department of Health attributed 160 hospitalizations and at least five deaths to improper use of home generators. Further, in 2005, the U.S. Consumer Product Safety Commission (CPSC) received reports of at least 64 people who died from carbon monoxide poisoning associated with portable generators.

Exhaust treatment devices like catalytic converter assemblies are generally known and available for use with combustion engines to aid in the removal of toxins from the exhausted gas. Often, a unique catalytic converter assembly may be required for use with each original equipment manufacturer because each original equipment manufacturer may employ a unique chassis, configuration, dimensions, components and the like. In addition, although some generator systems may include expensive and complex mechanisms for reducing the toxic output of gas-powered generators, such additional components may greatly increase the cost of the device, and may further reduce the portability of the generator by greatly increasing the size and/or weight of the generator. As such, the complexity of such systems and/or their limited ability to operate with systems from more than one manufacturer reduces the overall appeal and applicability of including such components.

In view of the above-mentioned drawbacks, it would be desirable to provide a cost-effective system that reduces and/or eliminates the dangerous emissions from combustion-driven appliances without affecting the overall portability and/or ease of use of these devices, as well as providing a system and/or accessory device that may be readily integrated with devices from various manufacturers.

### SUMMARY OF THE INVENTION

The present invention provides a cost-effective combustion generator enhancement device that reduces and/or eliminates the dangerous emissions from combustion-driven appliances without affecting the overall portability and/or ease of use of such devices, as well as a device that is readily compatible with a wide range of existing devise from multiple manufacturers. In particular, the present invention provides a combustion generator device releasably engageable with a portable generator. The device may include a housing defining an intake conduit having a first opening, an interior chamber in fluid communication with the first opening, and an outlet conduit having a second opening in fluid communication with the interior chamber. The intake conduit may define a first longitudinal axis, the interior chamber may define a second longitudinal axis, and the outlet conduit may define a third longitudinal axis. Further, the first and second longitudinal axes may be substantially perpendicular, the second and third longitudinal axes may be substantially perpendicular, and an angle between the first longitudinal axis of the intake conduit and the third longitudinal axis of the outlet conduit may be between approximately 110 and 120 degrees.

A flange may be coupled to the intake conduit in proximity to the first opening to facilitate attachment of the device to a generator. The flange can be angled between approximately 15 degrees and 25 degrees with respect to a cross-sectional plane of the intake conduit.

In addition, a catalytic conversion assembly may be positioned within at least a portion of the interior chamber, and a muffler assembly may be positioned within at least a portion of the outlet conduit. The catalytic conversion assembly may generally include a honeycomb structure, with at least one of a platinum, palladium, rhodium and cerium layer disposed on the honeycomb structure. The muffler assembly of the combustion generator device may include a first baffle element and a second baffle element, where the second baffle element is substantially perpendicular to the first baffle element. Moreover, each of the first and second baffle elements may define a substantially hollow cylindrical body having a plurality of apertures therethrough. A fibrous material may also be included to surround at least a portion of the muffler assembly.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a top view of an embodiment of a combustion generator enhancement device in accordance with the present invention;

FIG. 2 is a side view of an embodiment of a combustion generator enhancement device in accordance with the present invention;

FIG. 3 is an additional side view of an embodiment of a combustion generator enhancement device in accordance with the present invention;

FIG. 4 is a bottom view of an embodiment of a combustion generator enhancement device in accordance with the present invention; and

FIG. 5 is a cross-sectional view of an embodiment of a combustion generator enhancement device in accordance with the present invention.

### DETAILED DESCRIPTION OF THE INVENTION

The present invention provides a cost-effective combustion generator enhancement device that reduces and/or eliminates the dangerous emissions from combustion-driven appliances without affecting the overall portability and/or ease of use of such devices, as well as a device that is readily compatible with a wide range of existing devise from multiple manufacturers. A typical combustion-driven appliance is a gas-powered generator having an exhaust outlet where the toxic gaseous by-products of the generator are dispensed. Moreover, the exhaust outlet of the gas generator commonly includes either a muffler affixed to the exhaust outlet, or an attachment point for an after-market muffler to be installed.

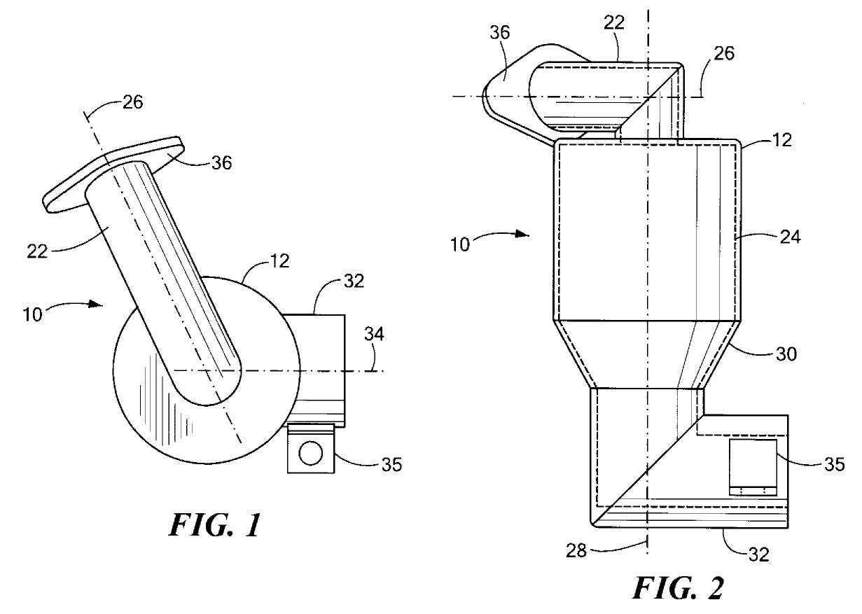

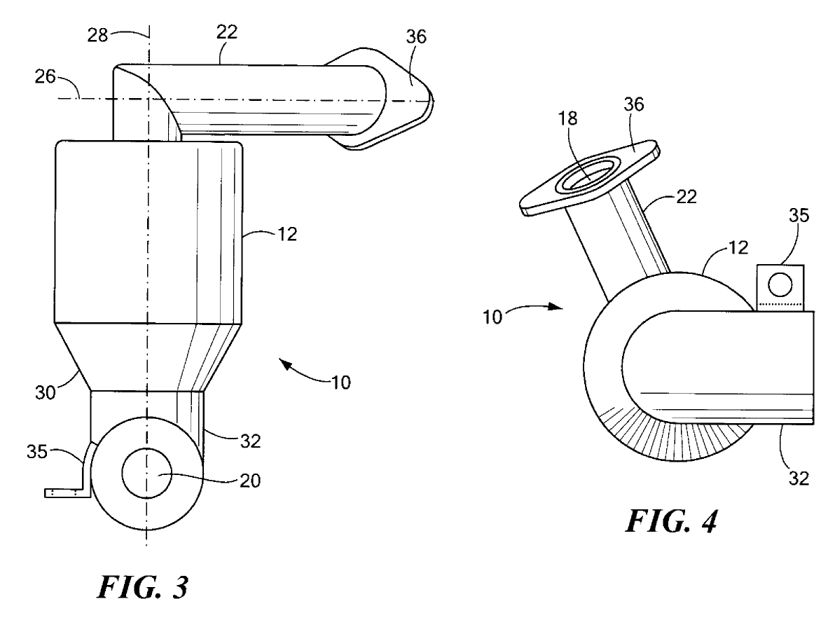

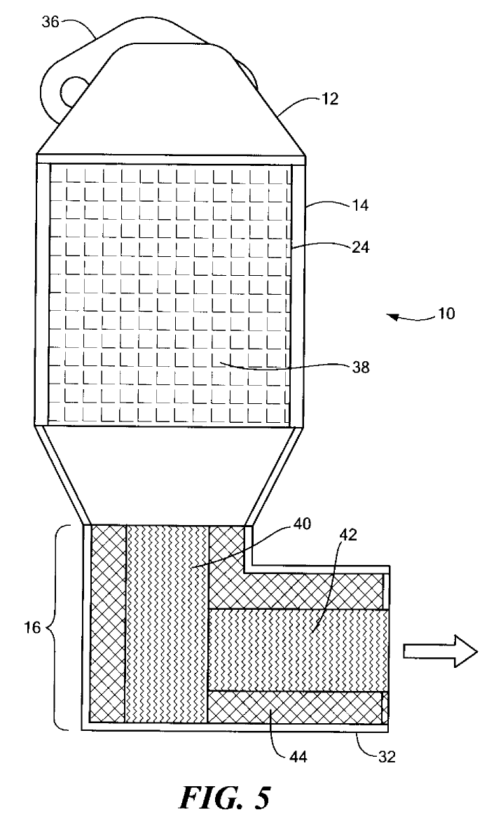

Now referring to FIGS. 1-5, an embodiment of a combustion generator enhancement device 10 is provided that is readily attachable to the exhaust outlet of a portable generator (not shown), i.e., the enhancement device 10 may be affixed to the generator where an after-market muffler was intended to be attached, or may replace a muffler already included on the particular generator. The enhancement device 10 generally includes a housing 12, where the housing 12 defines a fluid flow path therethrough. The enhancement device 10 may further generally include a catalytic conversion assembly 14 and a muffler assembly 16 disposed within at least a portion of the fluid flow path of the housing 12.

In particular, the housing 12 may include a first opening 18 on a first end engageable with or otherwise positionable in proximity to the exhaust outlet of a portable generator, where the first opening 18 is able to receive the gaseous output of the portable generator. The housing 12 may further define a second opening 20 in a second end opposite or otherwise located away from the first opening 18, where the second opening 20 allows the gaseous output received by the first opening 18 to subsequently exit the housing 12. The housing 12 may further include one or more conduit portions and/or lengths disposed between the first and second openings that provide a fluid flow path through the housing 12 and any components located therein.

For example, the housing 12 may include an intake conduit 22 having a passage therein, wherein the intake conduit 22 defines the first opening 18 and/or is in fluid communication with the first opening 18. The intake conduit 22 may include a length of tubing constructed from any suitable material, including metals, metal alloys, polymers, and/or ceramics. In particular, the intake conduit 22 may have an outer diameter of approximately 32 mm, an inner diameter of approximately 26 mm, and a length between approximately 50 mm and approximately 100 mm.

The housing 12 may further define an expanded portion defining an interior chamber 24 in fluid communication with the first opening 18 and/or the intake conduit 22. The interior chamber 24 may be defined by a portion of the housing 12 having a diameter and/or volume substantially larger than that of the intake conduit 22, for example, the interior chamber 24 may include a substantially cylindrical portion having an outer diameter of between approximately 70 mm to 100 mm. Moreover, the interior chamber 24 may have a length of between approximately 70 mm to 100 mm as well. The interior chamber 24 defined by the expanded portion of the housing 12 may be coupled at a substantially perpendicular angle to the intake conduit 22, i.e., a longitudinal axis 26 of the intake conduit 22 is substantially perpendicular to a longitudinal axis 28 of the interior chamber 24, such that exhaust gas drawn into the first opening 18 of the enhancement device 10 is directed into the intake conduit 22 and downward into the interior chamber 24 of the housing 12.

The housing 12 of the enhancement device 10 may further include an exhaust portion in fluid communication with and/or otherwise coupled to the interior chamber 24 opposite the intake conduit 22 to facilitate the exit of gas flowing through the enhancement device 10. In particular, the housing 12 may define a tapered portion 30 coupled to and extending from the interior chamber 24 of the housing 12, where the tapered portion 30 provides for a gradual decrease in the diameter of the fluid flow path defined by the enhancement device 10. For example, the tapered portion 30 may have an outer diameter of between approximately 70 mm to 100 mm proximate to the interior chamber 24, and further decrease to a diameter between approximately 40 mm to 60 mm at an end of the tapered portion 30 opposite of the interior chamber 24. The tapered portion 30 may further include a height of between approximately 25 mm and 40 mm.

The exhaust portion of the enhancement device 10 may further include an outlet conduit 32 coupled to the tapered portion of the housing 12, where the outlet conduit 32 defines the second opening 20 and diverts the fluid flow path through the enhancement device 10 into the surrounding atmosphere at an angle substantially perpendicular to the flow direction through the interior chamber 24. Moreover, an end portion and/or the second opening 20 defined by the outlet conduit 32 may be angled from the first opening 18 in the intake conduit 22 greater than approximately 90 degrees. In particular, the angle between a transverse axis of the first opening 18 and a transverse axis of the second opening 20 may be between approximately 90 degrees and 125 degrees to direct fluid flow exiting the enhancement device 10 away from the portable generator and the components thereof. In addition and/or alternatively, the longitudinal axis 26 of the intake conduit 22 may be angled from a longitudinal axis 34 of the outlet conduit 32 between approximately 90 degrees and 125 degrees to direct fluid flow exiting the enhancement device 10 away from the portable generator and the components thereof. Moreover, the outlet conduit 32 may include an “elbow” portion, or two conduit segments coupled substantially perpendicular to each other, where the “elbow portion” extends from the tapered portion at one end, and defines the second opening 20 at an opposite end for release of gaseous output into the atmosphere. The outlet conduit 32 may generally define an outer diameter of between approximately 40 mm and 60 mm, a height of between approximately 50 mm to 70 mm, and a length of between approximately 90 mm and 110 mm. The overall height of the enhancement device 10, i.e., a vertical distance between the first opening and the second opening, may be less than approximately 250 mm.

A bracket 35 may extend from or otherwise be coupled to a portion of the housing of the enhancement device of the present invention to facilitate attachment of the device to a portable generator. For example, an “L” shaped bracket may be coupled to the outlet conduit, wherein a portion of the bracket includes an opening or hole for the passage of a screw, bolt, or similar fixation element.

The enhancement device 10 of the present invention may include a flange 36 extending from or otherwise coupled to the intake conduit 22 in proximity to the first opening 18, where the flange 36 may facilitate fixation and/or engagement of the enhancement device 10 to a portable generator. The flange 36 may generally define first and second protruding portions, and may further have an angled orientation with respect to an axis or plane defined by a vertical cross-section of the first conduit when the enhancement device 10 is in an upright position. In particular, the flange 36 may be angled between approximately 15 and 25 degrees from a cross sectional plane of the intake conduit 22 and/or the vertical plane upon positioning of the enhancement device 10. In addition to and/or alternatively to the flange 36, the engagement between the enhancement device 10 and the generator may be achieved through the use of a threaded portion proximate to the first end of the housing 12 that is matable with a threaded portion (not shown) of the exhaust outlet of the generator. Moreover, the enhancement device 10 may be affixed to an exhaust outlet of a generator through the use of an adapter or other intermediate component (not shown) such that the housing 12 is easily coupled to the generator with sufficient clearance as not to interfere with other generator components and overall operation.

Of note, one or more portions of the housing may be movable with respect to one or more remaining portions of the housing to enable the enhancement device to be adjustably configurable for a particular application. For example, a portion of the intake conduit may be rotatably and/or movably adjusted with respect to the interior chamber. In addition, a portion of the outlet conduit may be rotatably and/or movably adjusted with respect to the interior chamber. The movement and/or rotatable capacity of these discrete components of the enhancement device may be achieved by a ball bearing and/or similar movable construct as is known in the art.

The catalytic conversion assembly 14 may be disposed within the flow path of the converter housing 12 for reacting with the poisonous gases produced by the generator. The conversion assembly 14 may generally include a corrugated structure 38 having herringbone and skew patterns and/or a honeycomb structure. For example, a band made of a heat-resistant steel sheet and a corrugated band obtained by forming a similar steel sheet into a wavy or sinuous form may be superposed one over the other in a contiguous relationship and are rolled together into a multilayered spiral form, thereby forming a honeycomb-shaped multilayered composite body (hereinafter called the “honeycomb core body”). The honeycomb body may axially define a number of network-patterned gas flow passages for allowing exhaust gas to flow therethrough.

The conversion assembly structure 38 may be constructed from a ceramic material made of ceramic, steel, stainless steel, chrome, or other suitable materials. In addition, the conversion assembly 14 may include reactive components, including platinum, palladium, rhodium, and cerium with the rare earth elements of scandium, yhrium, and the fifteen-lanthanide elements with atomic numbers 57-71, namely, lanthanum, praseodymium, neodymium, promethium, samarium, europium, gadolinium, terbium, dysprosium, holmium, erbium, thulium, ytterbium, and lutetium. The combination of these collective elements may be layered or otherwise disposed within the honeycomb and/or corrugated structure. Catalyst material can be applied over the entire surface area or selected portions depending upon the several factors, including the structure of the lip, catalyst's properties, cost, catalyzing reaction conditions, gas passageway flow conditions, and the like. The catalysts may comprise one or more catalyst materials that are wash coated, imbibed, impregnated, physisorbed, chemisorbed, precipitated, or otherwise applied to the catalyst assembly. For example, these reactive components may be disposed within a magnesium alum-silicate carrier having a low linear expansion, a low coefficient of thermal expansion, and a high resistance to thermal shock. The platinum and palladium components act as oxidizing catalysts for hydrocarbons and carbon monoxide. When these two products are oxidized, the resulting compounds are water and carbon dioxide, which are relatively harmless and environmentally friendly. The rhodium component behaves as a reduction catalyst for nitric oxides, thereby producing nitrogen and aiding in carbon dioxide production. Finally, the cerium element acts to promote oxygen storage in the converter element to improve the oxidation efficiency and conversion of the volatile exhaust gases to relatively benign end-products. The conversion structure 38 may thereafter be joined with the housing 12 of the enhancement device 10, substantially within the interior chamber 24 for example, by brazing or welding to withstand thermal expansion and stress due to the high temperature of exhaust gas, exothermic reactions of the exhaust gas induced by the catalyst, and the like.

The muffler assembly 16 of the enhancement device 10 of the present invention may be disposed within the housing 12 and the fluid flow path therethrough for reducing the sound output of the portable generator to which the enhancement device 10 may be coupled. For example, the muffler assembly 16 may include a baffle structure disposed substantially within the exhaust portion and/or outlet conduit 32 of the housing 12. In particular, the muffler assembly 16 may include a first baffle element 40, where the first baffle element 40 may define a substantially cylindrical body having a sidewall with a plurality of apertures therethrough. The first baffle element 40 may further define a hollow passage therethrough for the flow of gas. The first baffle element 40 may be disposed within a portion of the exhaust portion and/or outlet conduit 32 such that the passage therethrough is substantially parallel to the fluid flow path through the interior chamber 24 of the housing 12. The muffler assembly 16 may further include a second baffle element 42 substantially similar to the first baffle element 40, in that the second baffle element 42 may also define a substantially cylindrical body having a sidewall with a plurality of apertures therethrough. The second baffle element 42 may be disposed within the exhaust portion and/or outlet conduit 32 of the enhancement device 10, and the second baffle element 42 may further be substantially perpendicular to the first baffle element 40. The second baffle element 42 may extend from the first baffle element 40 to a location adjacent or otherwise in proximity to the second opening 20 of the enhancement device 10, through which fluid flow exits the device. Either and/or both of the first and second baffle elements may further be substantially surrounded by and/or wrapped within a fibrous fill material 44 such as fiberglass, mineral wool, and/or a ceramic able to withstand the substantial temperatures of the gas flowing through the enhancement device 10 at any given time and to further reduce the noise levels at which the portable generator may operate.

The substantially perpendicular orientation between the first and second baffle elements provides a substantial decrease in the noise levels at which the portable generator operates. For example, a 5500 watt generator from manufacturer Briggs & Stratton having a standard OEM muffler attached to it was sound tested at a distance of approximately 3 meters, and the generator emitted a noise level of 107 decibels during operation. The same generator was then sound tested with the enhancement device 10 of the present invention having the perpendicular baffle configuration described above, and the measured sound during operation was reduced to a level of 87 decibels. This significant reduction brings the noise operating level of the portable generator below the 90 decibel level typically associated with permanent damage or hearing loss for prolonged exposure.

In a particular use of the enhancement device 10 as described above, the enhancement device 10 is affixed to the output of a combustion-powered device, such as a gas powered generator or the like. Affixation of the enhancement device 10 to the portable generator may be facilitated by the flange 36 extending from the intake conduit 22. During operation of the generator, the toxic exhaust compounds, including hydrocarbons, carbon monoxide, etc., flow out of the generator exhaust and into the intake conduit 22 of the housing 12. The exhaust gases flow inward towards the conversion assembly 14 located within the interior chamber 24 of the housing 12, coming into contact and reacting with the catalytic elements layered or otherwise disposed on the converter structure. Subsequently, the toxic compounds are converted into harmless, environment-friendly products which then flow towards the exhaust portion of the enhancement device 10. The converted exhaust proceeds through the muffler assembly 16, which reduces the noise output of the generator, and subsequently, the substantially harmless, environmentally-friendly gaseous exhaust exits the housing 12 from the second opening 20 into the ambient atmosphere.

As a result, the generator may be operated efficiently, quietly, and without fear or danger of the potentially fatal build-up of poisonous by-products. Moreover, as the enhancement device 10 is easily attached and removed, the overall operation and use of generator is not affected, nor is the portability of the generator. Of note, the dimensions and angular orientations provided for the components of the enhancement device 10 of the present invention provide for versatile compatibility with a wide range of existing portable generators from manufacturers such as Brigg & Stratton®, Coleman®, Kawasaki®, Sears® Craftsman®, Troy-bilt®, and Yamaha®, to name a few, where previous devices likely had limited compatibility to a single generator type and/or manufacturer.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A combustion generator device releasably engageable with a portable generator, comprising:
a housing defining an intake conduit having a first opening, an interior chamber in fluid communication with the first opening, and an outlet conduit having a second opening in fluid communication with the interior chamber;
a catalytic conversion assembly positioned within at least a portion of the interior chamber; and
a muffler assembly positioned within at least a portion of the outlet conduit.

2. The combustion generator device according to claim 1, wherein the muffler assembly includes a fist baffle element and a second baffle element substantially perpendicular to the first baffle element.

3. The combustion generator device according to claim 2, wherein each of the first and second baffle elements includes a substantially hollow cylindrical body having a plurality of apertures therethrough.

4. The combustion generator device according to claim 1, further comprising a fibrous material surrounding at least a portion of the muffler assembly.

5. The combustion generator device according to claim 1, further comprising a flange coupled to the intake conduit in proximity to the first opening.

6. The combustion generator device according to claim 5, wherein the flange is angled between approximately 15 degrees and 25 degrees with respect to a cross-sectional plane of the intake conduit.

7. The combustion generator device according to claim 1, wherein the first opening defines a first transverse axis, the second opening defines a second transverse axis, and wherein an angle between the first and second transverse axes is between approximately 110 and 120 degrees.

8. The combustion generator device according to claim 1, wherein the intake conduit defines a first longitudinal axis, the outlet conduit defines a second longitudinal axis, and wherein an angle between the first and second longitudinal axes is between approximately 110 and 120 degrees.

9. The combustion generator device according to claim 1, wherein the intake conduit defines a first longitudinal axis, the interior chamber defines a second longitudinal axis, and wherein the first and second longitudinal axes are substantially perpendicular.

10. The combustion generator device according to claim 9, wherein the outlet conduit defines a third longitudinal axis, and wherein the second and third longitudinal axes are substantially perpendicular.

11. The combustion generator device according to claim 1, wherein the catalytic conversion assembly includes a honeycomb structure, with at least one of a platinum, palladium, rhodium and cerium layer disposed on the honeycomb structure.

12. The combustion generator device according to claim 1, wherein the housing has a height of less than approximately 250 mm.

13. A combustion generator device releasably engageable with a portable generator, comprising:
a housing defining an intake conduit having a first opening, an interior chamber in fluid communication with the first opening, and an outlet conduit having a second opening in fluid communication with the interior chamber, wherein the intake conduit defines a first longitudinal axis, the interior chamber defines a second longitudinal axis, and wherein the first and second longitudinal axes are substantially perpendicular;
a flange coupled to the intake conduit in proximity to the first opening;
a catalytic conversion assembly positioned within at least a portion of the interior chamber; and
a muffler assembly positioned within at least a portion of the outlet conduit.

14. The combustion generator device according to claim 13, wherein the outlet conduit defines a third longitudinal axis, and wherein the second and third longitudinal axes are substantially perpendicular.

15. The combustion generator device according to claim 14, wherein an angle between the first longitudinal axis of the intake conduit and the third longitudinal axis of the outlet conduit is between approximately 110 and 120 degrees.

16. The combustion generator device according to claim 13, wherein the muffler assembly includes a fist baffle element and a second baffle element substantially perpendicular to the first baffle element.

17. The combustion generator device according to claim 13, wherein the flange is angled between approximately 15 degrees and 25 degrees with respect to a cross-sectional plane of the intake conduit.

18. The combustion generator device according to claim 13, wherein the catalytic conversion assembly includes a honeycomb structure, with at least one of a platinum, palladium, rhodium and cerium layer disposed on the honeycomb structure.

19. The combustion generator device according to claim 13, wherein the housing has a height of less than approximately 250 mm.

20. A combustion generator device releasably engageable with a portable generator, comprising:
a housing defining an intake conduit having a first opening, an interior chamber in fluid communication with the first opening, and an outlet conduit having a second opening in fluid communication with the interior chamber;
wherein the intake conduit defines a first longitudinal axis, the interior chamber defines a second longitudinal axis, and the outlet conduit defines a third longitudinal axis;
wherein the first and second longitudinal axes are substantially perpendicular, wherein the second and third longitudinal axes are substantially perpendicular, and wherein an angle between the first longitudinal axis of the intake conduit and the third longitudinal axis of the outlet conduit is between approximately 110 and 120 degrees;
a flange coupled to the intake conduit in proximity to the first opening, wherein the flange is angled between approximately 15 degrees and 25 degrees with respect to a cross-sectional plane of the intake conduit;
a catalytic conversion assembly positioned within at least a portion of the interior chamber; and
a muffler assembly positioned within at least a portion of the outlet conduit, wherein the muffler assembly includes a fist baffle element and a second baffle element substantially perpendicular to the first baffle element.
